(19) United States
(12) Patent Application Publication
(10) Pub. No.: US 2026/0056613 A1
(43) Pub. Date: Feb. 26, 2026

(54) RENDERING TOUCH AND FEEL SENSATIONS DURING METAVERSE SESSION

(71) Applicant: SONY GROUP CORPORATION, TOKYO (JP)

(72) Inventors: KARTHIK GAYAKWAD, SAN DIEGO, CA (US); ANUBHAV SRIVASTAVA, SAN DIEGO, CA (US)

(21) Appl. No.: 18/811,925

(22) Filed: Aug. 22, 2024

(51) Int. Cl. G06F 3/01

(52) U.S. Cl. CPC G06F 3/016

(57) ABSTRACT

A system and method for rendering touch and feel sensations in an XR session, is provided. The system acquires immersive content associated with an XR session that is active on the XR device. The immersive content includes a virtual object that is representative of a real-world object. The system further detects an interaction between the virtual object and the user of the XR device. The system further determines control information comprising Electromagnetic Force (EMF) information associated with the virtual object and physical attributes associated with the virtual object, based on the interaction. The system further determines a plurality of electric current values corresponding to the plurality of EM actuators, based on the control information. The system further controls actuation of the plurality of EM actuators based on the plurality of electric current values.

### FIELD

Various embodiments of the disclosure relate to extended reality (XR) and haptics. More specifically, various embodiments of the disclosure relate to rendering of touch and feel sensations during a metaverse session.

### BACKGROUND

Advancements in virtual reality and extended reality devices result in rendering of an immersive virtual environment. Users may touch virtual objects associated with the environment, and feel sensations with the environment, during a metaverse session. Metaverse is a virtual world environment where users can interact with computer-generated objects and environments. Haptic feedback technology has grown in popularity in the metaverse in recent years. Haptic feedback gives users a tactile feedback, allowing the users to feel the virtual objects during interactions with such objects. However, haptic devices currently lacks many vital information like material, surface, form factor, and force approximation which does not convey when holding an object in virtual world. Some sophistication has happened in the field of medical or surgical equipment, but it is still limited to specific equipment and cannot be applied in the field of gaming or virtual world interactions. This lack of information in the feedback may result in a disconnect between the user and the virtual environment, lowering the overall user experience.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method for rendering of touch and feel sensations during a metaverse session, is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram that illustrates an exemplary network environment for rendering of touch and feel sensations during a metaverse session in XR environment, in accordance with an embodiment of the disclosure.

FIG. 2 is a block diagram that illustrates an exemplary system for rendering of touch and feel sensations during a metaverse session in the XR environment, in accordance with an embodiment of the disclosure.

FIGS. 3A and 3B are diagrams that illustrate exemplary operations for actuation of electromagnetic (EM) actuators, in accordance with an embodiment of the disclosure.

FIG. 4 is a block diagram that illustrates exemplary operations for control of actuation points, in accordance with an embodiment of the disclosure.

FIG. 5A is a block diagram that illustrates operations of an exemplary material prediction model, in accordance with an embodiment of the disclosure.

FIG. 5B is a block diagram that illustrates operations of an exemplary texture prediction model, in accordance with an embodiment of the disclosure.

FIG. 6A is a diagram that illustrates exemplary wearable haptic devices and haptic floor, in accordance with an embodiment of the disclosure.

FIG. 6B is a diagram that illustrates exemplary texture feedback device, in accordance with an embodiment of the disclosure.

FIG. 7 is a flowchart that illustrates operations for an exemplary method for rendering touch and feel sensations during a metaverse session in XR environment, in accordance with an embodiment of the disclosure.

### DETAILED DESCRIPTION

The present disclosure relates to a system and method for enhancing the haptic experience in extended reality (XR) environments. In some implementations, the system may include an XR device and a haptic feedback system, which may include a plurality of electromagnetic (EM) actuators in contact with a user's body portion. The system may be configured to acquire immersive content associated with an active XR session on the XR device, detect an interaction between a virtual object within the immersive content and the user, and determine control information based on this interaction. The control information may include Electromagnetic Force (EMF) information and physical attributes associated with the virtual object. The system may then determine a plurality of electric current values corresponding to the EM actuators based on the control information and control the actuation of the EM actuators based on these electric current values.

Current haptic devices often lack the ability to provide detailed sensory information such as material, surface texture, form factor, and force approximation. This limitation can hinder the user's ability to fully interact with and experience objects in a virtual environment. The disclosed system and method may address these limitations by using a set of algorithms and models to simulate the sense of touch and feel of objects in a virtual space. This may involve the use of a haptic floor to simulate gravity pull, a smart nanotech material called Nano-sense, and several models for object texture mapping, physical feature estimation, and electric mapping.

The disclosed system and method may be particularly suited for XR setups, offering a more immersive experience for users. It has potential applications in various industries, including the entertainment industry, medical or surgical equipment, and gaming rigs/setups, making it a versatile solution. In summary, the disclosed system and method may provide a more sophisticated and realistic haptic experience in virtual environments, overcoming the limitations of existing haptic devices.

By incorporating a comprehensive set of algorithms and models, the system may simulate a wide range of tactile sensations that may be contextually relevant to the virtual objects and the environment within the XR session. This may allow for a more nuanced and realistic interaction with virtual objects, enhancing the user's immersion and overall experience.

One of the primary advantages is the ability to provide detailed sensory information that goes beyond simple vibrations or force feedback. The system may simulate the texture, material properties, and even the weight of virtual objects, giving users a sense of holding or touching something real. This level of detail may be particularly beneficial in applications where the tactile experience is paramount, such as virtual training simulations for medical procedures or industrial design, where the feel of a material is as informative as its visual appearance.

Another advantage is the adaptability of the haptic feedback to the user's actions and the context of the virtual environment. Whether the user is gently touching a virtual petal or grasping a virtual tool, the system may adjust the feedback accordingly, providing a consistent and believable experience. This adaptability may extend to the user's movements and actions within the XR environment, ensuring that the haptic feedback remains synchronized with the visual and auditory components of the session.

Furthermore, the system's ability to store metadata corresponding to a multitude of virtual objects may allow for quick and accurate retrieval of the physical attributes and EMF information, streamlining the process of generating appropriate haptic feedback. This database-driven approach may enable scalability and ease of updating as new virtual objects and sensations are developed.

The disclosed system may also offer the potential for customization and personalization of haptic experiences. Users may adjust the intensity or type of feedback based on personal preference or specific application requirements, making the system versatile across different user groups and use cases. Overall, the disclosed system and method represent a substantial improvement in the field of haptic feedback for XR environments, providing users with a richer, more engaging, and more realistic experience that bridges the gap between the virtual and the real world.

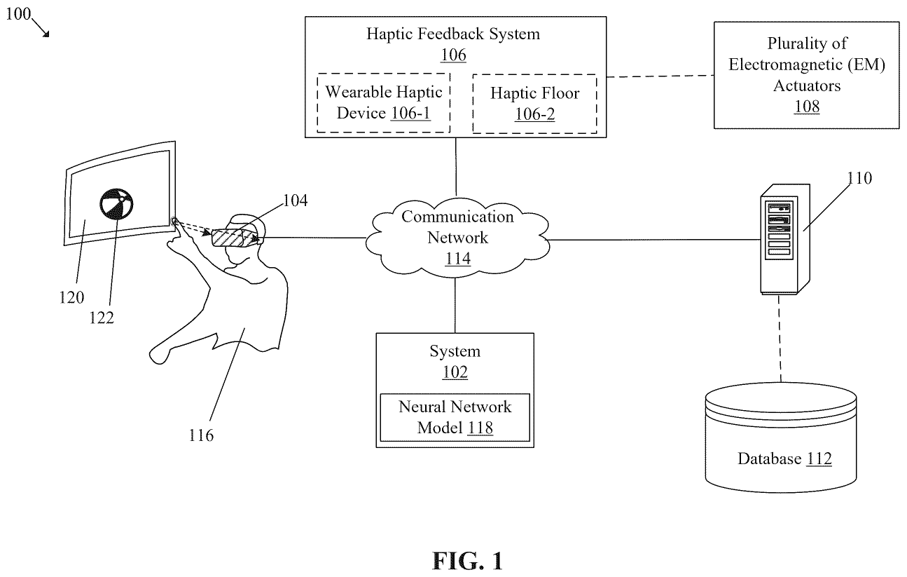

FIG. 1 is a diagram that illustrates an exemplary network environment for rendering of touch and feel sensations during a metaverse session in an XR environment, in accordance with an embodiment of the disclosure. With reference to FIG. 1, there is shown a network environment 100. The network environment 100 may include a system 102, an Extended Reality (XR) device 104, a haptic feedback system 106, and a server 110. The system 102 may communicate with the XR device 104, the haptic feedback system 106, and the server 110 through a communication network 114. In the network environment 100, there is further shown a user 116 who may wear the XR device 104 and the user 116 who may be in contact (e.g., wear and/or touch) with the haptic feedback system 106 to experience and interact with virtual objects of the immersive content that is rendered in an XR session on the XR device 104.

The system 102 may include suitable logic, circuitry, interfaces, and/or code that may be configured to execute operations associated with rendering of haptic feedback for the user 116. In a duration of the active session, the system 102 may control the haptic feedback system 106 to generate the haptic feedback based on interactions, such as activities or actions, of the user 116 with virtual object(s) in the XR session and immersive content associated with the XR session. The system 102 may control actuation of a plurality of Electromagnetic (EM) actuators 108 associated with the haptic feedback system 106 in order to generate the haptic feedback. The system 102 may also provide recommendations associated with the XR session, which may include, for example, actions that can be performed by the user 116 in the XR session or observations associated with the virtual object(s) in the XR session. Examples of the system 102 may include, but are not limited to, a computing device, a smartphone, a cellular phone, a mobile phone, a gaming device, a mainframe machine, a server, a computer workstation, and/or a consumer electronic (CE) device. In accordance with an embodiment, the system 102 may include the XR device 104 and the haptic feedback system 106.

The XR device 104 may include suitable logic, circuitry, interfaces, and/or code that may be configured to render immersive content (e.g., a metaverse including the virtual object(s) and background context) associated with the XR session. The system 102 may acquire the immersive content associated with the XR session that is active on the XR device 104. The immersive content may include a virtual object 122 that may be a representative of a real-world object. The virtual object 122 may include a bottle, a table, a chair, a ball, a vehicle, a weapon, and other related articles which are associated with the active XR session. In addition to the rendering of the immersive content, the XR device 104 may include one or more I/O devices that the user 116 may use to change the immersive content associated with the XR session, play or pause the immersive content, or zoom in or zoom out the immersive content or the virtual object(s) associated with the immersive content. In the XR session, the user 116 or a body portion of the user 116 may be shown as a digital avatar (e.g., a 2D avatar or a 3D avatar) or a 2D/3D model of the body portion (e.g., arms or hands) of the user 116. The user 116 may use the one or more I/O devices to change or update the digital avatar or the model.

In accordance with an embodiment, the XR device 104 may be a head-mounted display such as an XR headset or an XR helmet. The XR device 104 may include an optical system that may be configured to project the immersive content on a display that may be placed in front of one or both eyes of the user 116, while wearing the XR device 104. In accordance with an embodiment, the XR device 104 may be an eyewear device or a handheld device. In an embodiment, the XR device 104 may include an inertial measurement unit for a VR experience of the user 116. Examples of the XR device 104 may include, but are not limited to, an Extended reality headset, an optical head-mounted display, an augmented reality headset, a mixed reality headset, a virtual reality (VR) headset, virtual reality glasses, a virtual reality eye lens, or a handheld XR device.

The haptic feedback system 106 may include suitable logic, circuitry, and interfaces that may be configured to generate a haptic feedback. The haptic feedback may be generated based on interactions (such as a contact) between the user 116 and the virtual object 122 included in the XR session. The haptic feedback may be generated while the immersive content is rendered on the XR device 104 and for a portion of a duration of the interaction. The haptic feedback system 106 may include a wearable haptic device 106-1 and a haptic floor 106-2, which may be equipped with the plurality of EM actuators 108. The wearable haptic device 106-1 may include a first set of EM actuators of the plurality of EM actuators 108, which may be located at first defined positions on the wearable haptic device 106-1. In an instance, the first defined positions may include fingertips carved on the wearable haptic device 106-1. The haptic floor 106-2 may include a second set of EM actuators of the plurality of EM actuators 108 located at second defined positions on the haptic floor 106-2. In an instance, the second defined positions may include one or more sections of the haptic floor 106-2, where the one or more sections may be in form of, but not limited to, rectangular or square grids, circular or radial or hexagonal structures. In one embodiment, the one or more sections may be evenly distributed across the haptic floor 106-2. In another embodiment, the one or more sections may be grouped together in the haptic floor 106-2.

The wearable haptic device 106-1 may be worn on one or more anatomical portions of the body (interchangeably, referred to as body portions, herein), such as hands, arms, chest, waist, hips, toes, or feet of the user 116. In at least one embodiment, the wearable haptic device 106-1 may be a full body suit with the first set of EM actuators spread throughout the surface of the body suit at first defined positions. The generated haptic feedback may cause the user 116 to experience a tactile sensation on the one or more body portions. In some embodiments, the wearable haptic device 106-1 may include sensors, such as tactile sensors or haptic sensors, which may allow measurement of force of movement of the one or more body portions of the user 116 (in real-world) or pressure of a human touch on the wearable haptic device 106-1 which may be in contact with the one or more body portions. The sensors may detect the force or pressure during activities such as interactions of the user 116 with the virtual object 122 in the rendered XR session based on the detection movement or pressure, and correspondingly the wearable haptic device 106-1 may generate the haptic feedback.

Examples of the wearable haptic device 106-1 may include, but are not limited to, a haptic glove, a wired glove with haptic actuators, a gaming glove with haptic actuators, a wearable fingertip haptic device (such as a haptic thimble or a touch thimble), a graspable haptic device (which may generate kinesthetic sensations, such as a sensation of movement, position and force in skin, muscles, tendons, and joints of a wearer), or a wearable device (which generates tactile sensations, such as a pressure, friction, or temperature in the skin of a wearer), joysticks with haptic actuators, mouse, finger pad, robotic handle, gripper, a humanoid robotic hand with haptic actuators, a wearable garment with haptic actuators, a wearable device with haptic actuators, or any device in a form of a wearable belt with haptic actuators.

The haptic floor 106-2 may include suitable logic, circuitry, and interfaces that may be configured to generate the haptic feedback for the user 116. The haptic feedback may be generated based on interactions (such as a contact) between the user 116 and the virtual object 122 included in the XR session. In operation, the system 102 may predict a weight of the virtual object 122. Further, the haptic feedback may be generated based on the predicted weight of the virtual object 122, so that the user 116 may feel weight of the virtual object 122 while the immersive content is rendered on the XR device 104 and for the portion of a duration of the interaction. The second set of EM actuators of the plurality of EM actuators 108 may be disposed evenly on the haptic floor 106-2, which may correspond to the second defined positions on the haptic floor 106-2. In some embodiments, the haptic floor 106-2 may include sensors, such as tactile sensors or haptic sensors, which may allow measurement of force (for example, gravitational pull or weight of the virtual object 122) on of the one or more body portions of the user 116 (in real-world) or pressure of a human touch on the haptic floor 106-2. The sensors may detect the force or pressure during activities such as interactions of the user 116 with the virtual object 122 in the rendered XR session based on the detected force or pressure, and correspondingly the haptic floor 106-2 may generate the haptic feedback.

The haptic feedback system 106 may also include a texture feedback device, which may include a plurality of actuation points that may be arranged in a form of a grid shape. The system 102 may determine a contact plane between the virtual object 122 and the body portion of the user 116. Based on the contact plane and the physical attributes, the system 102 may further determine surface texture data that includes a grid representation of a surface texture of the real-world object. The system 102 may control actuation of the plurality of actuation points based on the grid representation. The plurality of actuation points may be made up of specific materials, which may change their texture upon actuation. The materials at the plurality of actuation points may change their texture to produce a texture according to the virtual object 122, which may be similar to the surface texture of the real-world object.

The server 110 may include suitable logic, circuitry, interfaces, and/or code that may be configured to receive requests from the system 102 or the XR device 104 for immersive content that may be rendered on the XR device 104. The server 110 may be configured to store immersive content (such as gaming content, multimedia entertainment content, sports content, or an electronic health record) and stream the stored immersive content to the system 102 or the XR device 104 based on the reception of the requests. The server 110 may stream the immersive content through hyper-text transfer protocol (HTTP) requests, web applications, cloud applications, repository operations, file transfer, and the like. Example implementations of the server 110 may include, but are not limited to, a database server, a file server, a web server, an application server, a mainframe server, a cloud computing server, or a combination thereof.

In at least one embodiment, the server 110 may be implemented as a plurality of distributed cloud-based resources by use of several technologies that are well known to those ordinarily skilled in the art. A person with ordinary skill in the art will understand that the scope of the disclosure may not be limited to the implementation of the server 110, the system 102, and the XR device 104 as separate entities. In certain embodiments, the functionalities of the server 110 may be incorporated in its entirety or at least partially in the system 102 or the XR device 104, without a departure from the scope of the disclosure.

The communication network 114 may include a communication medium through which the system 102, the XR device 104, the haptic feedback system 106, and the server 110 may communicate with each other. The communication network 114 may be a wired or wireless communication network. Examples of the communication network 114 may include, but are not limited to, Internet, a Wireless Fidelity (Wi-Fi) network, a Personal Area Network (PAN), a Local Area Network (LAN), or a Metropolitan Area Network (MAN). The system 102 may be configured to connect to the communication network 114 in accordance with various wired and wireless communication protocols. Examples of such wired and wireless communication protocols may include, but are not limited to, at least one of a Transmission Control Protocol and Internet Protocol (TCP/IP), Mobile Wireless Communication (such as 4th Generation Long Term Evolution (LTE) or 5th Generation New Radio), User Datagram Protocol (UDP), Hypertext Transfer Protocol (HTTP), File Transfer Protocol (FTP), Zig Bee, EDGE, Institute of Electrical and Electronics Engineers (IEEE) 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In operation, the system 102 may be configured to detect a XR session that may be active on the XR device 104. The XR device 104 may render immersive content (for example, 3D virtual game content) associated with an XR environment 120 (for example, a playing space) in a duration of the XR session. The XR environment 120 may include the digital avatar of the user 116, who may wear the XR device 104. The XR environment 120 may include a model of the body portion of the user 116, which may be in contact with the haptic feedback system 106. The XR environment 120 may include the virtual object 122 (for example, a virtual ball or a virtual bottle) that may be representative of a real-world object (i.e., an actual bottle) in the XR environment 120. The XR environment 120 may also include other digital avatars and/or virtual objects (for example, a table, a vehicle, a residence, and the like).

The system 102 may be configured to acquire the immersive content based on the detection of the XR session that is active on the XR device 104. The immersive content may include a virtual object that may be representative of a real-world object. The immersive content may be acquired from the XR device 104 The acquisition of the immersive content may correspond to extraction of a set of frames of the immersive content that may be rendered on the XR device 104 during the active XR session. The frames may include 3D data frames and/or 2D images of the scene(s) depicted in the XR session. Additionally, or alternatively, the acquisition of the immersive content may include extraction of audio included in the immersive content.

After the acquisition, the system 102 may be further configured to detect the interaction between the virtual object 122 and the user 116 of the XR device 104. In accordance with an embodiment, the system 102 may detect a contact between 3D surface points of the 3D model and 3D points of the virtual object 122, and detect the interaction based on the contact. Based on the contact between the 3D surface points of the 3D model and the 3D points of the virtual object 122, the system 102 may retrieve RGBD data of the real-world object that represents the virtual object 122. The retrieved RGBD data may be stored in the server 110 or a memory, where the memory may be a part of the server 110, or the memory may also be an independent element in the system 102. The retrieved RGBD data may also be stored in a database 112. The user 116 may interact with the virtual object 122 by holding the virtual object 122, moving the virtual object 122, or touching the virtual object 122 to feel the surface texture or material of the virtual object 122. The user 116 may also zoom in or zoom out the virtual object 122 or the XR session. The database 112 may include metadata corresponding to each virtual object of a plurality of virtual objects associated with the XR session. The metadata for each virtual object of the plurality of virtual objects may include the physical attributes and Electromagnetic (EMF) information associated with corresponding virtual object.

As an example, the EMF information may include an EMF map, which may include a matrix of EMF values between a plurality of contact planes and the plurality of EM actuators 108, where the plurality of contact planes may correspond to a plurality of planes of contact between (the body portion of) the user 116 and the virtual object 122. In an embodiment, the plurality of contact planes may pertain to holding planes or positions via which the virtual object 122 can be held. The plurality of contact planes may vary for distinct virtual objects.

The physical attributes may include volumetric attributes (for example, size and shape of the virtual object), material attributes (for example, type of material such as plastic, metallic, and non-metallic, and the like), surface texture attributes (for example, rough, smooth, bumpy, feathery, velvety, and the like), and a physical weight associated with the virtual object 122. The system 102 may communicate with a neural network model 118, which may be stored either in the database 112 or the server 110. The system 102 may further compute each EMF value of the matrix of EMF values based on application of the neural network model 118 on the volumetric attributes, the material attributes, the surface texture attributes, and the physical weight. The system 102 may determine control information associated with the virtual object 122 based on the interaction. The control information may include the EMF information associated with the virtual object 122 and physical attributes associated with the virtual object 122.

The system 102 may extract an image of a contact plane to predict material information and texture information. The system 102 may extract the image of the contact planefrom the retrieved RGBD data based on the contact. Thereafter, the system 102 may feed the image as an input to a material prediction model. The material prediction model may be neural network-based model, for example, Convolutional Neural Network (CNN), Recurrent Neural Network (RNN), Artificial Neural Network (ANN), and the like. Further, the material prediction model may generate material information for the virtual object 122 based on the fed input, which may be further included as the material attributes into the physical attributes of the virtual object 122. The system 102 may retrieve a surface image of the real-world object based on the image and may further feed the retrieved surface image as an input to a texture prediction model, which may be neural network-based model, for example, Convolutional Neural Network (CNN), Recurrent Neural Network (RNN), Artificial Neural Network (ANN), and the like. The texture prediction model may generate surface texture data that may include a grid representation of a surface texture of the real-world object along the contact plane. The generated surface data may be further included as the surface texture attributes into the physical attributes of the virtual object 122.

The system 102 may detect, based on the interaction, one or more contact planes between the virtual object 122 and the 3D model of the body portion of the user 116 included in the immersive content. Such contact planes may be selected from the plurality of contact planes, where the one or more contact planes may correspond to actual planes of contact between the 3D model (the body portion of) the user 116 and the virtual object 122 during the interaction in the XR session. Further, the system 102 may extract a plurality of EMF values from the EMF information based on the detected one or more contact planes. The plurality of EMF values may correspond to the detected one or more contact planes and may be derived from the matrix of EMF values. Furthermore, the system 102 may determine the plurality of electric current values based on the extracted plurality of EMF values.

The system 102 may further control actuation of the plurality of EM actuators 108 based on the plurality of electric current values. The actuation of the plurality of EM actuators 108 may aid the haptic feedback system 106 in producing the haptic feedback. The system 102 may supply electric current to the plurality of EM actuators 108 based on the determined plurality of electric current values, such that a flow of the electric current through each EM actuator of the plurality of EM actuators 108 may generate a magnetic field with a magnetic pole that is same for each of the plurality of EM actuators 108. Thus, the plurality of EM actuators 108 may repel one another to an extent for providing a feeling that the user 116 is holding the virtual object 122. The plurality of EM actuators 108 may include EM electric drives, such as but not limited to, EM motors, and EM sensors, tactile sensors, and haptic sensors.

In an embodiment, the first set of EM actuators of the plurality of EM actuators 108 (equipped in the wearable haptic device 106-1) may produce tactile sensations on the body portion of the user 116 while the user 116 wears the wearable haptic device 106-1. The wearable haptic device 106-1 may be adapted to be directly worn at the body portion of the user 116, or the wearable haptic device 106-1 may be adapted to be adhesively attached to the body portion of the user 116. In another embodiment, the second set of EM actuators of the plurality of EM actuators 108 (equipped in the haptic floor 106-2) may produce tactile sensations for the user 116. In accordance with an embodiment, the generated haptic feedback may include one or more of a kinesthetic feedback, a tactile feedback, or a thermal feedback.

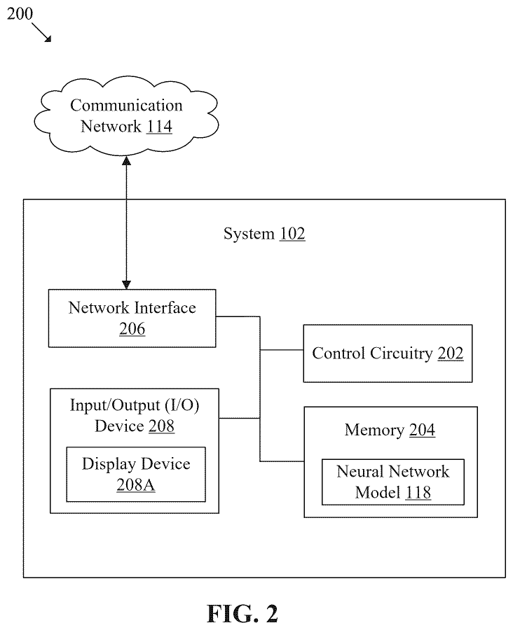

FIG. 2 is a block diagram that illustrates an exemplary system for rendering of touch and feel sensations during a metaverse session in an XR environment, in accordance with an embodiment of the disclosure. FIG. 2 is explained in conjunction with elements from FIG. 1. With reference to FIG. 2, there is shown a block diagram 200 of the system 102. The system 102 may include control circuitry 202, a memory 204, and a network interface 206.

In at least one embodiment, the system 102 may include the XR device 104 and the haptic feedback system 106. In at least one embodiment, the memory 204 may store metadata corresponding to each virtual object of a plurality of virtual objects. The metadata for each virtual object of the plurality of virtual objects may include the corresponding physical attributes and the EMF information. The XR device 104 may include an input/output (I/O) device 208. The I/O device 208 may include a display device 208A, for example. The control circuitry 202 may be communicatively coupled to the memory 204, the network interface 206, the XR device 104, and the haptic feedback system 106, through a wired or wireless communication interface of the system 102.

The control circuitry 202 may include suitable logic, circuitry, and interfaces that may be configured to execute program instructions associated with a set of operations to be executed by the system 102. The control circuitry 202 may include one or more processing units, which may be implemented as an integrated processor or a cluster of processors that perform the functions of the one or more processing units, collectively. The control circuitry 202 may be implemented based on a number of processor technologies known in the art. Example implementations of the control circuitry 202 may include, but are not limited to, an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

The memory 204 may include suitable logic, circuitry, and/or interfaces that may be configured to store instructions executable by the control circuitry 202. The memory 204 may be configured to store the control information including the physical attributes and the EMF information for each of the plurality of virtual objects. In at least one embodiment, the memory 204 may further store information associated with a rendered XR environment 120. The stored information may include physical attributes associated with virtual objects that may be included in the XR environment 120, scene information associated with the XR environment 120, and activities in which the 3D model associated with the user 116 may be engaged. The control circuitry 202 may retrieve the stored information for determination of contact planes between the virtual object 122 and the body portion of the user 116 in a currently rendered XR environment 120. Example implementations of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

Each neural network model 118 may include one or more machine learning models, which may be in a hierarchical arrangement or a flat arrangement. By way of example and not limitation, each neural network model 118 may include at least one of a multi-spatial attention network, an Long Short-Term Memory (LSTM) network, a Bidirectional-LSTM (Bi-LSTM) model, a self-attention transformer model, a feature extraction network, a dimensionality reduction model, a transformer decoder, an attention-based Convolutional Neural Network (CNN), a transformer encoder, a classifier model, a Hybrid Auto Encoder (HAE) model including a CNN, an LSTM network, an LSTM encoder, an LSTM decoder, and a dense layer, a Hybrid Recurrent Neural Network (HRNN) model, a Reinforcement Learning (RL)-based model, a Generative Adversarial Network (GAN) model, a collaborative filtering model, and a Self-Supervised Generative Adversarial Network (SSGAN).

In accordance with an embodiment, each model may include a neural network. A neural network may be referred to as a computational network or a system of artificial neurons which is arranged in a plurality of layers. The plurality of layers of the neural network may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before or after training the neural network on a training dataset.

Each model may include electronic data, which may be implemented as, for example, a software component of an application executable on the system 102. The model may rely on libraries, external scripts, or other logic/instructions for execution by a processing device, such as the control circuitry 202. For example, the neural network may rely on external code or software packages to execute on a computing device, such as the control circuitry 202 and to perform machine learning tasks such as an analysis of immersive content rendered on the XR device 104 for detection and tracking of virtual objects and the 3D models associated with the user 116 in the XR environment 120, a determination of the physical attributes associated with each of the virtual objects, a determination of scene information associated with the XR environment 120, a determination of activities in which the 3D model may be engaged in the XR environment 120, a detection of an interaction between the 3D model and a virtual object, a determination of contact planes, and a controlled actuation of the plurality of EM actuators 108 by supplying appropriate electric current through each of the plurality of EM actuators 108 to provide the user 116 a tactile feedback, via the haptic feedback system 106.

Each model may be implemented using hardware including a processor, a microprocessor (e.g., to perform or control performance of one or more operations), a field-programmable gate array (FPGA), a coprocessor (such as an inference accelerator), or an application-specific integrated circuit (ASIC). Alternatively, each model may be implemented using a combination of hardware and software.

The network interface 206 may include suitable logic, circuitry, interfaces, and/or code that may be configured to establish a communication between the system 102, the XR device 104, the haptic feedback system 106, and the server 110, via the communication network 114. The network interface 206 may be implemented using various known technologies to support wired or wireless communication of the system 102 with the communication network 114. The network interface 206 may include, but may not be limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VOIP), light fidelity (Li-Fi), Wi-MAX, a protocol for email, instant messaging, and/or Short Message Service (SMS).

The I/O device 208 (in the XR device 104) may include suitable logic, circuitry, interfaces, and/or code that may be configured to receive a user input associated with rendering of an immersive content associated with an XR environment (say, XR environment 120 of FIG. 1), control the 3D model associated with the digital avatar of the user or a model associated with a particular body portion of the user 116 that may be included in the rendered XR environment 120. Additionally, or alternatively, the I/O device 208 may render, as an output, immersive content that may include the #D model associated with the user 116 and virtual objects. The I/O device 208 may include various input and output devices, which may be configured to communicate with the control circuitry 202. Examples of the input devices may include, but are not limited to, a touch screen, a keyboard, a mouse, a joystick, a game controller, a brain-machine interface (BMI), a VR remote, a gesture-based controller, a wearable controller (e.g., a garment with sensors to track and record body movements), and/or a microphone. Example of the output devices may include, but is not limited to, a VR display, a flat display (such as the display device 208A), or an audio reproduction device.

The display device 208A may include suitable logic, circuitry, interfaces, and/or code that may be configured to render the immersive content associated with the XR environment 120. The display device 208A may be realized through several known technologies such as, but not limited to, a Liquid Crystal Display (LCD) display, a Light Emitting Diode (LED) display, a plasma display, and/or an Organic LED (OLED) display technology, and/or other display technologies. In accordance with an embodiment, the display device 208A may refer to a display screen of smart-glass device, a 3D display, a see-through display, a projection-based display, an electro-chromic display, and/or a transparent display.

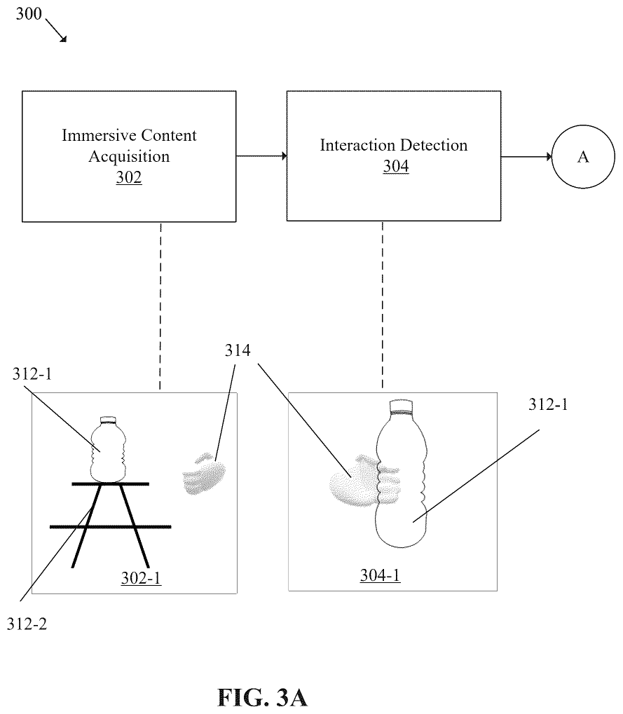

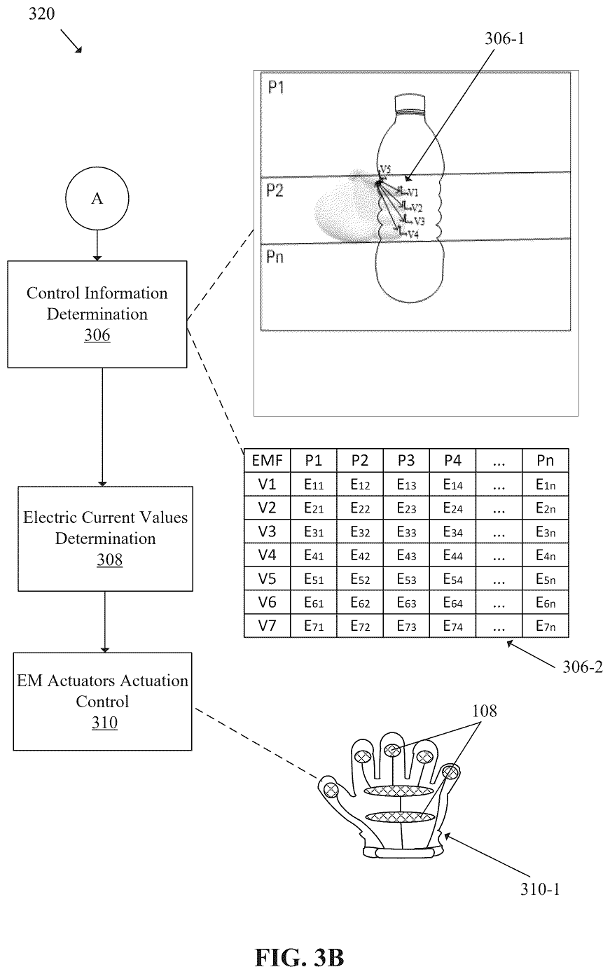

The operations executed by the system 102, as described in FIG. 1, may be performed by the control circuitry 202. Operations executed by the control circuitry 202 are described in detail, for example, in FIGS. 3, 4, 5A, 5B, 6A, 6B, and 7.

FIGS. 3A and 3B are diagrams that illustrate exemplary operations for actuation of electromagnetic (EM) actuators, in accordance with an embodiment of the disclosure. FIGS. 3A and 3B is explained in conjunction with elements from FIG. 1 and FIG. 2. With reference to FIGS. 3A and 3B, there are shown exemplary block diagrams 300 and 320. The exemplary block diagrams 300 and 320 may include a sequence of operations that may be executed by the control circuitry 202 by use of the neural network model 118. The sequence of operations may be executed for actuation of electromagnetic (EM) actuators to provide a tactile feedback to the user 116 of the virtual object 122 that may be included in an XR environment 120 rendered on the XR device 104. The sequence of operations that may start at 302 and may terminate at 310.

At 302, immersive content associated with an XR session active on the XR device 104 may be acquired. The virtual object 122 may be a 3D or 2D representation of a real-world object or an object of imagination. In at least one embodiment, the control circuitry 202 may be configured to acquire the immersive content from the memory 204 of the system 102. Additionally, or alternatively, the immersive content may be acquired from the server 110. The immersive content may include a set of frames that may be rendered in a duration of an XR session on the XR device 104. The immersive content may further include one or more virtual objects in the frames, audio content for play back, and a 3D model of a digital avatar or a body portion (such as palm, foot, and the like) of the user. The control circuitry 202 may further acquire one or more frame of the set of frames associated with the immersive content and may then detect the virtual object 122 in the acquired one or more frames. Temporal features of each frame of the one or more frames may be extracted based on a result of a detection of the virtual object 122 in a corresponding frame and frames of the set of frames that may precede or succeed the corresponding frame.

In accordance with an embodiment, temporal features of a first frame of the set of frames may be extracted based on a correlation between a determined feature in a region of interest in the first frame, and the determined features in regions of interest in one or more frames that precede or succeed the first frame. For example, the features may include color, texture, shape, position, edge, corner, ridge, and/or pixel intensity. The virtual object 122 may be detected in the region of interest in the frame and the regions of interest in the one or more frames. Similarly, the temporal features of other frames of the set of frames may be extracted.

As shown in 302-1, immersive content may include one or more virtual objects, such as bottle 312-1, table 312-2, and 3D model 314 of hand of the user 116, audio content for play back, and a 3D model pertaining to digital avatar or a body portion (such as palm or foot) of the user 116.

At 304, an interaction between the virtual object 122 and the user 116 of the XR device 104 may be detected. The 3D model of the body portion of the user 116 (for example, a 3D digital avatar or a 3D symbol) may be included in the immersive content. The system 102 may detect a contact between 3D surface points of the 3D model and 3D points of the virtual object 122. The system 102 may detect the interaction based on the contact between the 3D surface points of the 3D model and the 3D points of the virtual object 122. As shown in 304-1, the contact between the 3D model 314 of the hand of the user 116 and 3D points of the bottle 312-1 may be detected, and correspondingly the interaction may be detected based on the contact.

Based on the contact between the 3D surface points of the 3D model and the 3D points of the virtual object 122, the control circuitry 202 may retrieve RGBD data of the real-world object that represents the virtual object 122, which may be stored in the server 110, the database 112, or the memory 204. The user 116 may interact with the virtual object 122 by holding the virtual object 122, moving the virtual object 122, or feeling the surface texture or material of the virtual object 122. The user 116 may also zoom in or zoom out the virtual object 122 in the XR session. Metadata corresponding to each virtual object of the plurality of virtual objects associated with the XR session may be stored in the system 102. The metadata for each virtual object of the plurality of virtual objects may include the physical attributes and the EMF information associated with corresponding virtual object.

At 306, control information associated with the virtual object 122 may be determined. The control circuitry 202 may determine the control information associated with the virtual object 122 based on the interaction. The control information may include Electromagnetic Force (EMF) information associated with the virtual object 122 and physical attributes associated with the virtual object 122. The EMF information may include an EMF map (for instance, EMF map 306-2), which may include a matrix of EMF values between a plurality of contact planes and the plurality of EM actuators 108. The plurality of contact planes may correspond to a plurality of planes of contact between (the body portion of) the user 116 (possible number of planes of contact) and the virtual object. The physical attributes may include volumetric attributes (for example, size and shape of the virtual object), material attributes (for example, type of material such as plastic, metallic, and non-metallic), surface texture attributes (for example, rough, smooth, bumpy, feathery, velvety) and a physical weight associated with the virtual object 122. The system 102 may compute each EMF value of the matrix of EMF values based on application of a neural network model (say, the neural network model 118 of FIG. 1, here) on the volumetric attributes, the material attributes, the surface texture attributes, and the physical weight. Further, the control circuitry 202 may determine one or more contact planes 306-1 between the virtual object 122 and the body portion of the user 116. The one or more contact planes 306-1 may be detected based on the contact between the 3D points of the virtual object 122 and the 3D surface points of the 3D model of the body portion of the user 116.

In an embodiment, based on the interaction, the control circuitry 202 may derive vectors V1, V2, V3, V4, V5, V6 and V7 (as shown in F) based on the contact between the 3D points of the bottle 312-1 and the 3D surface points of the 3D model 314 of the hand of the user 116. Further, the one or more contact planes 306-1 may be detected based on the derived vectors. The control circuitry 202 may further extract a plurality of EMF values from the EMF map 306-2 based on the detected one or more contact planes 306-1. The plurality of EMF values may correspond to the detected one or more contact planes 306-1 and may be derived from the matrix of EMF values. By way of example, and not limitation, each of the plurality of EMF values may be computed using equation 1, as follows:

$${E}_{ij} = {\int }_{i , j = 1}^{7 , n} {EMF}_{oem ( i )} {W}_{ij} \qquad ( 1 )$$

where, Eᵢⱼ=Electromagnetic force between two contact planes,
EMFₒₑₘ₍ᵢ₎=approximate emf for each of the vectors, and
Wij=weight learnt based on reinforcement learning for each emf of the vectors (V1-V7) for respective contact planes (P1, P2 . . . . Pn) for each object of interest in the metaverse or virtual world.

At 308, electric current values may be determined. The control circuitry 202 may determine the electric current values based on the extracted plurality of EMF values. The electric current values may be determined so that the plurality of EMF values may be maintained. In accordance with an embodiment, the system 102 may include an in-built electric power source such as a rechargeable battery or a power bank, from which the flow of electric current may be ensured. Alternatively, the system 102 may be connected to an independent electric power source such as a power grid, solar grid, and solar panel.

At 310, actuation of the plurality of EM actuators may be controlled. The control circuitry 202 may control the actuation of the plurality of EM actuators 108 based on the plurality of electric current values (as shown in 310-1). The actuation of the plurality of EM actuators 108 may aid the haptic feedback system 106 in producing the haptic feedback (Hₜ). By way of example, and not limitation, the haptic feedback may be computed using equation 2, as follows:

$${H}_{f} = {\int }_{1}^{k} E ( k ) \cdot S ( k ) \qquad ( 2 )$$

where, E(k)=EMF of kth virtual object, and
S(k)=EMF of the haptic floor for the kth virtual object.

The system 102 may supply electric current to the plurality of EM actuators 108 based on the determined plurality of electric current values, such that a flow of the electric current through each EM actuator of the plurality of EM actuators 108 may generate a magnetic field for each of the plurality of EM actuators 108. The magnetic field may be generated with a magnetic pole that is same for each of the plurality of EM actuators 108. Thus, the plurality of EM actuators 108 may repel one another to the point where the user 116 believes he or she is holding the virtual object 122.

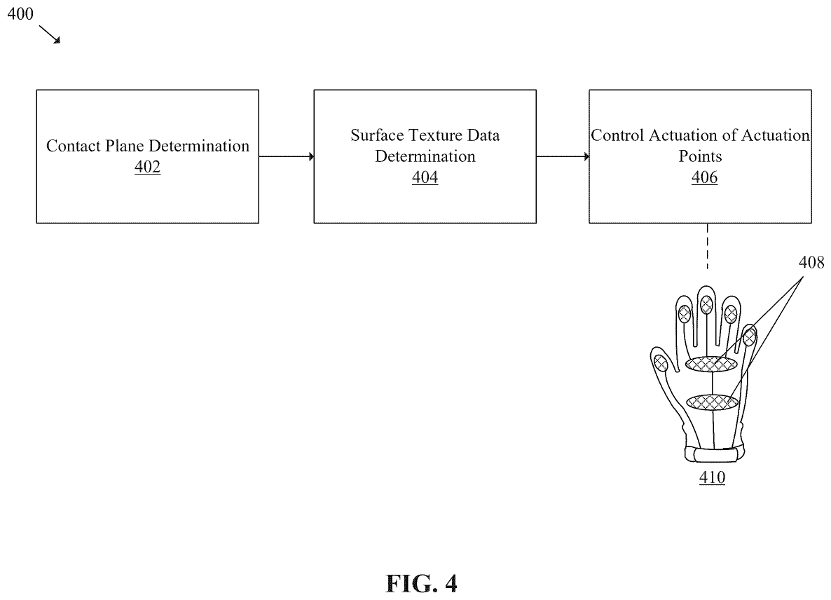

FIG. 4 is a block diagram that illustrates exemplary operations for control of actuation points, in accordance with an embodiment of the disclosure. FIG. 4 is explained in conjunction with elements from FIG. 1, FIG. 2, FIG. 3A, and FIG. 3B. With reference to FIG. 4, there is shown an exemplary block diagram 400. The exemplary block diagram 400 may include a sequence of operations that may be executed by the control circuitry 202 by use of a texture prediction model. The sequence of operations may be executed to predict a surface texture of a virtual object (say, virtual object 122 of FIG. 1) and further control actuation of a plurality of actuation points 408 of a texture feedback device 410 to facilitate the user 116 to feel texture of the virtual object 122. The sequence of operations may start at 402 and may terminate at 406.

At 402, a contact plane may be determined. The control circuitry 202 may determine a contact plane between the virtual object 122 (for instance, the bottle 312-1) and the body portion of the user 116 based on a contact between 3D surface points of the 3D model of the texture feedback device 410 or the model of the corresponding body portion of the user 116 and 3D points of the virtual object 122 (the bottle 312-1).

At 404, surface texture data may be determined. The control circuitry 202 may determine surface texture data, which may include a grid representation of a surface texture of the real-world object, based on the contact plane and the physical attributes. The control circuitry 202 may determine surface texture data with the aid of the texture prediction model. The texture prediction model may be trained using reinforcement learning. For example, the control circuitry 202 may retrieve a surface image of the real-world object based on the image and may generate surface texture data that may include a grid representation of a surface texture of the real-world object along the contact plane, based on application of a texture prediction model on the surface image.

At 406, actuation of the plurality actuation points 408 may be controlled. The control circuitry 202 may control actuation of the plurality of actuation points based on the grid representation. The plurality of actuation points may be made up of specific materials, which may change their texture upon actuation. The materials at the plurality of actuation points may change their texture to produce a texture according to the virtual object 122, which may be same as or similar to the surface texture of the real-world object.

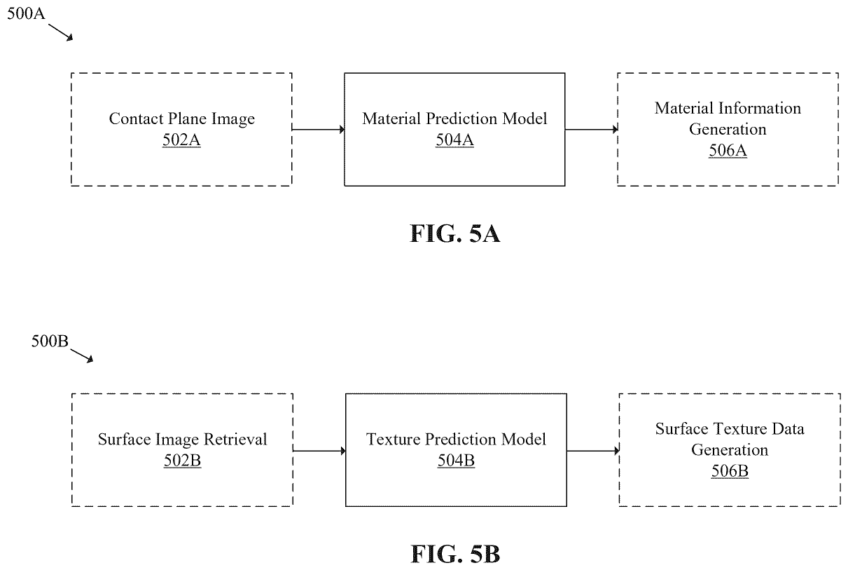

FIG. 5A is a block diagram that illustrates operations of an exemplary material prediction model, in accordance with an embodiment of the disclosure. FIG. 5A is explained in conjunction with elements from FIG. 1, FIG. 2, FIG. 3A, FIG. 3B, and FIG. 4, and FIG. 5. With reference to FIG. 5A, there is shown an exemplary block diagram 500A for a material prediction model 504A.

In operation, the control circuitry 202 may retrieve RGBD data based on the contact. The control circuitry 202 may extract an image of a contact plane (for example, image 502A) from the retrieved RGBD data based on the detected contact. The control circuitry 202 may feed the image 502A as an input to the material prediction model 504A. The material prediction model 504A may be a neural network-based model, for example, Convolutional Neural Network (CNN), Recurrent Neural Network (RNN), Artificial Neural Network (ANN), and the like. The material prediction model 504A may be trained to predict material information for multiple objects using reinforcement learning. Further, the material prediction model 504A may generate material information 506A for the virtual object 122 based on the fed input. The material information 506A may be included as material attributes (of the physical attributes) of the virtual object 122.

FIG. 5B is a block diagram that illustrates operations of an exemplary texture prediction model, in accordance with an embodiment of the disclosure. FIG. 5B is explained in conjunction with elements from FIG. 1, FIG. 2, FIG. 3A, FIG. 3B, FIG. 4, and FIG. 5A. With reference to FIG. 5B, there is shown an exemplary block diagram 500B of a texture prediction model 504B. The control circuitry 202 may retrieve RGBD data based on the contact. The control circuitry 202 may extract an image of a contact plane from the retrieved RGBD data based on the detected contact. The control circuitry 202 may further retrieve a surface image 502B of the real-world object based on the extracted image. The control circuitry 202 may feed the surface image 502B as an input to the texture prediction model 504B. The texture prediction model 504B may be a neural network-based model, for example, Convolutional Neural Network (CNN), Recurrent Neural Network (RNN), Artificial Neural Network (ANN), and the like. The texture prediction model 504B may be trained to predict surface texture data for multiple objects using reinforcement learning. During Inference, the texture prediction model 504B may generate, based on the surface image 502B, surface texture data 506B that may include a grid representation of a surface texture of the real-world object along the contact plane.

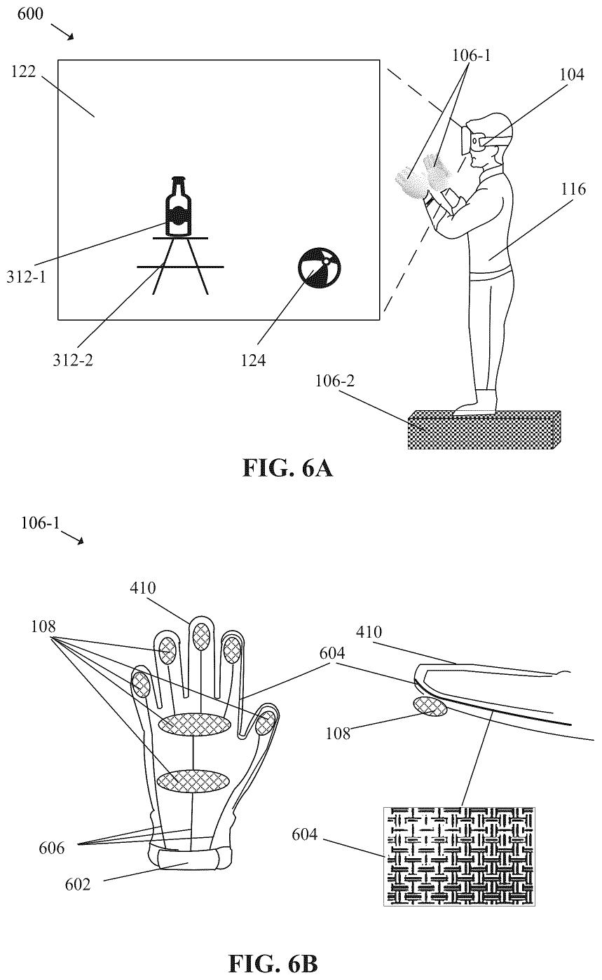

FIG. 6A is a diagram that illustrates exemplary wearable haptic devices and haptic floor, in accordance with an embodiment of the disclosure. FIG. 6A is explained in conjunction with elements from FIG. 1, FIG. 2, FIG. 3A, FIG. 3B, FIG. 4, FIG. 5A and FIG. 5B. With reference to FIG. 6A, there is shown an exemplary diagram 600. The exemplary diagram 600 illustrates components of the haptic feedback system 106. The haptic feedback system 106 may include one or more wearable haptic devices 106-1 and a haptic floor 106-2, which may be equipped with the plurality of EM actuators 108. The one or more wearable haptic devices 106-1 may include a first set of EM actuators of the plurality of EM actuators 108, which may be located at first defined positions on the wearable haptic devices 106-1. The haptic floor 106-2 may include a second set of EM actuators of the plurality of EM actuators 108 located at second defined positions on the haptic floor 106-2.

The one or more wearable haptic devices 106-1 may be worn on one or more body portions, such as hands, arms, chest, waist, hips, toes, or feet of the user 116. In an exemplary embodiment, the one or more wearable haptic devices 106-1 (as shown in FIG. 6A) may be haptic gloves worn by the user 116 on his/her hands to interact with virtual object(s) in the XR session rendered at the XR device 104. A haptic feedback may be generated by the first set of EM actuators of the plurality of EM actuators 108, located at the haptic gloves, based on the interaction between the user 116 and the virtual object 122. The generated haptic feedback may cause the user 116 to experience a tactile sensation on hands of the user 116. In some embodiments, the wearable haptic devices 106-1 may include sensors, such as tactile sensors or haptic sensors, which may allow measurement of force of movement of the hands of the user 116 (in real-world) or pressure of a human touch on the wearable haptic devices 106-1, which may be in contact with the body portions. The sensors may detect the force or pressure during activities such as interactions of the user 116 with the virtual object 122 in the rendered XR session based on the detection movement or pressure, and correspondingly the wearable haptic devices 106-1 may generate the haptic feedback.

The haptic floor 106-2 may generate the haptic feedback based on interactions (such as a contact) between the user 116 and the virtual object 122 included in the XR session. The haptic feedback may be generated based on a predicted weight of the virtual object 122, which may be considered as an effect of gravity, so that the user 116 may experience the weight of the virtual object 122 while the immersive content is rendered on the XR device 104 and for the portion of a duration of the interaction. The second set of EM actuators of the plurality of EM actuators 108 may be disposed evenly at second defined positions on the haptic floor 106-2. In some embodiments, the haptic floor 106-2 may include sensors, such as tactile sensors or haptic sensors that may allow measurement of force (for example, gravitational pull or weight of the virtual object 122) on the one or more body portions of the user 116 (in real-world) or pressure of a human touch on the haptic floor 106-2 while trying to hold the virtual object 122. The sensors may detect the force or pressure during activities such as interactions of the user 116 with the virtual object 122 in the rendered XR session based on the detection movement or pressure, and correspondingly the haptic floor 106-2 may generate the haptic feedback.

FIG. 6B is a diagram that illustrates exemplary texture feedback device, in accordance with an embodiment of the disclosure. FIG. 6B is explained in conjunction with elements from FIG. 1, FIG. 2, FIG. 3A, FIG. 3B, FIG. 4, FIG. 5A, FIG. 5B, and FIG. 6A. With reference to FIG. 6B, there is shown an exemplary diagram of the wearable haptic device 106-1. The exemplary diagram illustrates a texture feedback device (for example, the texture feedback device 410). The texture feedback device 410 may include a plurality of actuation points 604 that may be arranged in a form of a grid shape. The control circuitry 202 may determine a contact plane between the virtual object 122 and the body portion of the user 116. The control circuitry 202 may further determine surface texture data comprising a grid representation of a surface texture of the real-world object, based on the contact plane and the physical attributes. The control circuitry 202 may further control actuation of the plurality of actuation points based on the grid representation. The plurality of actuation points 604 may be made up of specific materials, which may change their texture upon actuation. The materials at the plurality of actuation points 604 may change their texture to produce a texture according to the virtual object 122, which may be similar to or same as the surface texture of the real-world object.

In accordance with an embodiment, the plurality of actuation points 604 and the plurality of EM actuators 108 may be connected to a controller 602 via wires 606. The controller 602 may include an in-built battery, which may facilitate flow of the electric current from the controller 602 to the plurality of actuation points 604 and the plurality of EM actuators 108. Hence, the controller 602, via the in-built battery, may control actuation of the plurality of actuation points 604 and the plurality of EM actuators 108.

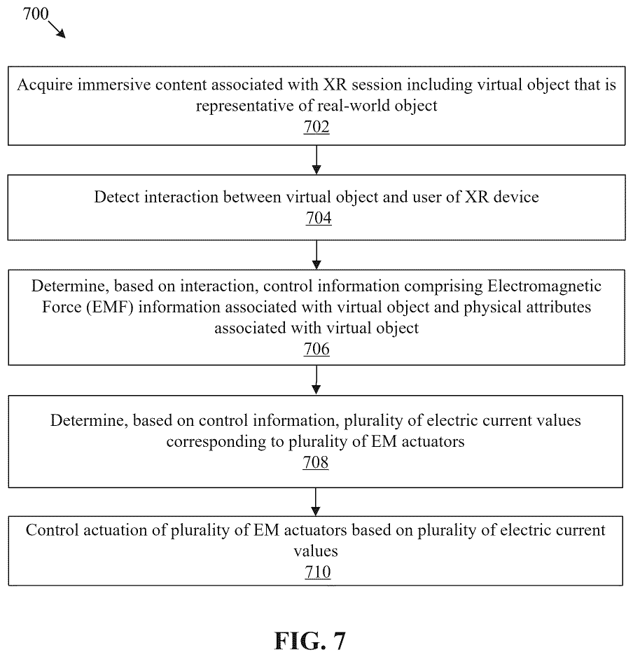

FIG. 7 is a flowchart that illustrates operations for an exemplary method for rendering of touch and feel sensations during a metaverse session in XR environment, in accordance with an embodiment of the disclosure. FIG. 7 is explained in conjunction with elements from FIG. 1, FIG. 2, FIG. 3A, FIG. 3B, FIG. 4, FIG. 5A, FIG. 5B, FIG. 6A, and FIG. 6B. With reference to FIG. 7, there is shown a flowchart 700. The operations from 702 to 710 may be implemented by any computing system, such as, by the system 102, or the control circuitry 202 of the system 102, of FIG. 1. The operations may start at 702 and may proceed to 710.

At 702, immersive content associated with an XR session may be acquired, which is active on the XR device 104. The immersive content may include a virtual object 122 that is representative of a real-world object an active VR session. In at least one embodiment, the control circuitry 202 may be configured to detect the XR session that may be active on the XR device 104. The XR device 104 may render the immersive content associated with an XR environment 120 in the duration of the VR session. The VR environment may include a digital avatar, or a model associated with a body portion of the user, who may wear the XR device 104 and may be associated with the haptic feedback system 106. The details of acquisition of the immersive content associated with the XR session that is active on the XR device 104, is described, for example, in FIG. 3A.

At 704, an interaction between the virtual object 122 and the user 116 of the XR device 104 may be detected. The 3D model of the body portion of the user 116 (for example, a 3D digital avatar or a 3D symbol) may be included in the immersive content. The control circuitry 202 may detect a contact between 3D surface points of the 3D model and 3D points of the virtual object 122, and further the interaction may be detected based on the contact. The user 116 may interact with the virtual object 122 to hold the virtual object 122, or move the virtual object 122, or feel surface texture or material of the virtual object 122. The user 116 may also zoom in or zoom out the virtual object 122 or the XR session. A metadata corresponding to each virtual object of a plurality of virtual objects associated with the XR session may be there in the system 102. The metadata for each virtual object of the plurality of virtual objects may include the physical attributes and the EMF information associated with corresponding virtual object. The details of detection of the interaction between the virtual object 122 and the user 116 of the XR device 104, is described, for example, in FIG. 3A.

At 706, control information may be associated with the virtual object 122 may be determined. The control circuitry 202 may determine control information associated with the virtual object 122, based on the interaction. The control information may include Electromagnetic Force (EMF) information associated with the virtual object 122 and physical attributes associated with the virtual object 122. The EMF information may include an EMF map (for instance EMF map 306-2), which may further include a matrix of EMF values between a plurality of contact planes and the plurality of EM actuators 108, where the plurality of contact planes may correspond to a plurality of planes of contact between (the body portion of) the user 116 and the virtual object 122. The physical attributes may include volumetric attributes (for example, size and shape of the virtual object), material attributes (for example, type of material such as plastic, metallic, and non-metallic), surface texture attributes (for example, rough, smooth, bumpy, feathery, velvety) and a physical weight associated with the virtual object 122. The system 102 may compute each EMF value of the matrix of EMF values based on application of a neural network model on the volumetric attributes, the material attributes, the surface texture attributes, and the physical weight. The details of determination of the control information, is described, for example, in FIG. 3B.

At 708, a plurality of electric current values corresponding to the plurality of EM actuators may be determined. In at least one embodiment, the control circuitry 202 may be configured to determine the electric current values based on the plurality of EMF values, which may be extracted from the EMF information based on one or more contact planes. The one or more contact planes between the virtual object 122 and a 3D model of the body portion included in the immersive content may be detected based on the interaction between the user 116 and the virtual object 122. The electric current values may be determined so that the control circuitry 202 may be able to produce EMF values same as the extracted plurality of EMF values. The system 102 may include an in-built electric power source such as a rechargeable battery or a power bank, from which the flow of electric current may be ensured. The system 102 may be in contact with an independent electric power source such as a power grid, solar grid, and solar panel. The details of determination of determination of the electric current values, is described, for example, in FIG. 3B.

At 710, actuation of the plurality of EM actuators may be controlled. The control circuitry 202 may control actuation of the plurality of EM actuators 108 based on the plurality of electric current values. The actuation of the plurality of EM actuators 108 may aid the haptic feedback system 106 in producing the haptic feedback. The system 102 may supply electric current to the plurality of EM actuators 108 based on the determined plurality of electric current values, such that a flow of the electric current through each EM actuator of the plurality of EM actuators 108 may generate a magnetic field for each of the plurality of EM actuators 108. The magnetic field may be generated with a magnetic pole that is same for each of the plurality of EM actuators 108, hence the EM actuators 108 may repel one another to an extent for providing a feeling that the user 116 is holding the virtual object 122. The plurality of EM actuators 108 may include EM electric drives such as EM motors, and EM sensors, tactile sensors, and haptic sensors. The details of control of actuation of the plurality of EM actuators 108, described, for example, in FIG. 3B.

The operations may also include computing each EMF value of the matrix of EMF values based on application of a neural network model on the volumetric attributes, the material attributes, the surface texture attributes, and the physical weight.

Although the flowchart 700 is illustrated as discrete operations, such as 702, 704, 706, 708, and 710, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (such as the system 102). The computer-executable instructions may cause the machine and/or computer to perform operations that include acquire immersive content associated with an XR session that is active on an XR device (such as the XR device 104), wherein the immersive content may include a virtual object (such as the virtual object 122) that may be representative of a real-world object. The XR device 104 may render immersive content associated with an XR environment 120 in a duration of the XR session. The XR environment 120 may further include a digital avatar or a symbol of a user, who may wear the XR device 104. The operations may further include detection of an interaction between the virtual object 122 and the user of the XR device 104. The operations may further include determination of control information comprising Electromagnetic Force (EMF) information associated with the virtual object 122 and physical attributes associated with the virtual object 122, based on the interaction. The operations may further include determine a plurality of electric current values corresponding to the plurality of EM actuators (such as the plurality of EM actuators 108), based on the control information. The operations may further include control of actuation of the plurality of EM actuators 108 based on the plurality of electric current values.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to conduct the methods described herein may be suited. A combination of hardware and software may be a general-purpose computer system with a computer program that, when loaded and executed, may control the computer system such that it conducts the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to conduct these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. A system, comprising:
control circuitry communicatively coupled to an Extended Reality (XR) device and a haptic feedback system comprising a plurality of electromagnetic (EM) actuators in contact with a body portion of a user of the XR device,
wherein the control circuitry is configured to:
acquire immersive content associated with an XR session that is active on the XR device, wherein the immersive content includes a virtual object that is representative of a real-world object;
detect an interaction between the virtual object and the user of the XR device;
determine, based on the interaction, control information comprising Electromagnetic Force (EMF) information associated with the virtual object and physical attributes associated with the virtual object;
determine, based on the control information, a plurality of electric current values corresponding to the plurality of EM actuators; and
control actuation of the plurality of EM actuators based on the plurality of electric current values.

2. The system according to claim 1, wherein the control circuitry is further configured to detect the XR session that is active on the XR device, wherein the XR device is configured to render the immersive content in a duration of the XR session.

3. The system according to claim 1, wherein the haptic feedback system further comprises a texture feedback device comprising a plurality of actuation points that is arranged in a form of a grid shape.

4. The system according to claim 3, wherein the control circuitry is further configured to:
determine a contact plane between the virtual object and the body portion of the user;
determine, based on the contact plane and the physical attributes, surface texture data comprising a grid representation of a surface texture of the real-world object; and
control actuation of the plurality of actuation points based on the grid representation.

5. The system according to claim 1, wherein the immersive content includes a 3D model of the body portion of the user, and
wherein the control circuitry is further configured to detect a contact between 3D surface points of the 3D model and 3D points of the virtual object, and
the interaction is detected based on the contact.

6. The system according to claim 5, wherein, based on the contact between the 3D surface points of the 3D model and the 3D points of the virtual object, the control circuitry is further configured to:
retrieve RGBD data of the real-world object that represents the virtual object; and
extract an image of a contact plane from the RGBD data based on the contact.

7. The system according to claim 6, wherein the control circuitry is further configured to:
feed the image as an input to a material prediction model; and
generate, as an output, material information for the virtual object based on the input to the material prediction model, wherein the physical attributes include the material information.

8. The system according to claim 6, wherein the control circuitry is further configured to:
retrieve a surface image of the real-world object based on the image; and
generate surface texture data that includes a grid representation of a surface texture of the real-world object along the contact plane, based on application of a texture prediction model on the surface image,
wherein the physical attributes include the surface texture data.

9. The system according to claim 1, further comprising a memory that is configured to store a database that includes metadata corresponding to each virtual object of a plurality of virtual objects, wherein the metadata for each virtual object of the plurality of virtual objects includes the physical attributes and the EMF information.

10. The system according to claim 1, wherein the EMF information comprises an EMF map comprising a matrix of EMF values between a plurality of contact planes and the plurality of EM actuators.

11. The system according to claim 10, wherein the physical attributes comprise volumetric attributes, material attributes, surface texture attributes, and a physical weight associated with the virtual object, and
wherein the control circuitry is further configured to compute each EMF value of the matrix of EMF values based on application of a neural network model on the volumetric attributes, the material attributes, the surface texture attributes, and the physical weight.

12. The system according to claim 1, wherein the control circuitry is further configured to:
detect, based on the interaction, one or more contact planes between the virtual object and a 3D model of the body portion included in the immersive content;
extract a plurality of EMF values from the EMF information based on the detected one or more contact planes; and
determine the plurality of electric current values based on the extracted plurality of EMF values.

13. The system according to claim 1, wherein the haptic feedback system comprises a wearable haptic device and a haptic floor.

14. The system according to claim 13, wherein the wearable haptic device comprises a first set of EM actuators of the plurality of EM actuators at first defined positions on the wearable haptic device, and
the haptic floor comprises a second set of EM actuators of the plurality of EM actuators at second defined positions on the haptic floor.

15. The system according to claim 1, wherein the control circuitry is further configured to supply electric current to the plurality of EM actuators based on the determined plurality of electric current values, and
wherein a flow of the electric current through each EM actuator of the plurality of EM actuators generates a magnetic field with a magnetic pole that is same for each of the plurality of EM actuators.

16. A method, comprising:
in a system that is communicatively coupled to an Extended Reality (XR) device and a haptic feedback system comprising a plurality of electromagnetic (EM) actuators in contact with a body portion of a user of the XR device:
acquiring immersive content associated with an XR session that is active on the XR device, wherein the immersive content includes a virtual object that is representative of a real-world object;
detecting an interaction between the virtual object and the user of the XR device;
determining, based on the interaction, control information comprising Electromagnetic Force (EMF) information associated with the virtual object and physical attributes associated with the virtual object;
determining, based on the control information, a plurality of electric current values corresponding to the plurality of EM actuators; and
controlling actuation of the plurality of EM actuators based on the plurality of electric current values.

17. The method according to claim 16, wherein the EMF information comprises an EMF map comprising a matrix of EMF values between a plurality of contact planes and the plurality of EM actuators, and
the physical attributes comprise volumetric attributes, material attributes, surface texture attributes, and a physical weight associated with the virtual object.

18. The method according to claim 17, further comprising computing each EMF value of the matrix of EMF values based on application of a neural network model on the volumetric attributes, the material attributes, the surface texture attributes, and the physical weight.

19. The method according to claim 17, further comprising:
detecting, based on the interaction, one or more contact planes between the virtual object and a 3D model of the body portion included in the immersive content;
extracting a plurality of EMF values from the EMF information based on the detected one or more contact planes; and
determining the plurality of electric current values based on the extracted plurality of EMF values.

20. A non-transitory computer-readable medium having stored thereon, computer-executable instructions that when executed by a system communicatively coupled to an Extended Reality (XR) device and a haptic feedback system, causes the system to execute operations, the operations comprising:
acquiring immersive content associated with an XR session that is active on the XR device, wherein the immersive content includes a virtual object that is representative of a real-world object;
detecting an interaction between the virtual object and a user of the XR device;
determining, based on the interaction, control information comprising Electromagnetic Force (EMF) information associated with the virtual object and physical attributes associated with the virtual object;
determining, based on the control information, a plurality of electric current values corresponding to a plurality of EM actuators of the haptic feedback system,
wherein the plurality of EM actuators are in contact with a body portion of a user of the XR device; and
controlling actuation of the plurality of EM actuators based on the plurality of electric current values.
